(19) United States
(12) Patent Application Publication
(10) Pub. No.: US 2007/0044057 A1
(43) Pub. Date: Feb. 22, 2007

(54) Semiconductor device with multiple wiring layers and moisture-protective ring

(75) Inventors: Kazuhiro Kitani, Kawasaki (JP); Kenji Hashimoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/389,304

(22) Filed: Mar. 27, 2006

(30) Foreign Application Priority Data
Aug. 22, 2005 (JP) 2005-239747

(51) Int. Cl. G06F 17/50

(52) U.S. Cl. 716/8

(57) ABSTRACT

A semiconductor device with a space-saving design of common power lines shared by a plurality of function macros. An LSI chip has a plurality of wiring layers, a moisture-protective ring, and a plurality of function macros (e.g., I/O macros and I/O macro groups). Each function macro has a VSS power supply terminal that is electrically connected to the moisture-protective ring. This connection enables the moisture-protective ring to function as part of a common VSS power line for the function macros. The proposed architecture reduces the space required for routing VSS power lines inside the moisture-protective ring, thus contributing to space-saving LSI designs.

### CROSS-REFERENCE TO RELATED APPLICATIONS

This application is based upon and claims the benefits of priority from the prior Japanese Patent Application No. 2005-239747, filed on Aug. 22, 2005, the entire contents of which are incorporated herein by reference.

### BACKGROUND OF THE INVENTION

1. Field of the Invention

The present invention generally relates to semiconductor devices and particularly to a semiconductor device having multiple wiring layers and a moisture-protective ring.

2. Description of the Related Art

Recent years have seen an increasing demand for highly space-saving designs of electrical appliances, particularly in the field of portable devices. Achieving this goal requires smaller, more function-rich large-scale integrated circuit (LSI) products. To integrate many different functions in a single chip, the recent LSI design technology offers a variety of modularized circuit elements, called function macros in a single device, each providing a particular function. LSI chips contain a great number of such function macros.

Each function macro has a power supply terminal for VSS voltage. In some conventional LSI design, VSS power supply terminals of a group of function macros are wired to a common VSS power line. Because of their high-speed operation at low operating voltages, the recent function macros are sensitive to noise on their VSS power supply terminals providing a reference potential for each macro. Electrical noise on a common VSS power line could cause a malfunction of macro circuits connected to that line. Analog function macros are particularly sensitive to such VSS noise. A conventional approach to solve this problem is to isolate the VSS power line of analog function macros from that of digital function macros.

The above issue aside, some existing LSI chips have a moisture-protective ring (see, for example, Japanese Patent Application Publication No. 2-123753 (1990)). Intrusion of water or etchant into an LSI chip would cause damage or degradation to the chip. To prevent this problem, a ring-shaped moisture-protective pattern is fabricated in a region between the scribe lines and I/O (input/output) pads of an LSI chip. Moisture-protective rings often have a multilayer structure to adapt to the multilayer wiring architecture of LSI chips.

A couple of LSI chip designs having a moisture-protective ring are known in the art. FIG. 1 shows a simplified layout of a conventional LSI chip 800 with a moisture-protective ring 801. The moisture-protective ring 801 is formed in an outer region of the LSI chip 800 to protect its function macros and wiring patterns located inside. In FIG. 1, the bold-line boxes represent I/O pads 802. The other boxes are I/O macros 803 and 804 and I/O macro groups 805, 806, 807, and 808, the circuits for input and/or output of signals and VSS. While the LSI chip 800 actually contains other kinds of function macros, FIG. 1 omits them for the sake of simplicity.

More specifically, the double-line boxes indicate VSS I/O macros, and the other boxes represent signal I/O macros. Although not shown in FIG. 1, those I/O macros 803 and 804 are coupled to arithmetic/logic operators, memory modules, or other function macros, as are the I/O macro groups 805 to 808.

For example, the I/O macros 803, 804 and I/O macro group 807 are connected to a particular function macro (not shown), the I/O macro groups 805, 806 are connected to another function macro (not shown). The LSI chip 800 has separate VSS power supply terminals for different kinds of function macros to reduce the noise mentioned above. The same kind of function macros shares VSS power supply terminals through VSS power lines 809, 810, and 811. Each VSS power line 809, 810, and 811 is routed from a VSS I/O macro to the VSS power supply terminal (not shown) of a signal I/O macro.

Some existing LSI chips have a feature of protecting itself from electro-static discharge (ESD). ESD may happen when an electrically conductive object (including a human body) comes close to, or actually comes into contact with, a terminal of an LSI chip, causing damage to some function macro elements in the chip.

FIG. 2 shows a simplified layout of a conventional LSI chip with ESD protection capabilities. The illustrated LSI chip 900 has a similar layout to the aforementioned LSI chip 800 of FIG. 1. A moisture-protective ring 901 runs along the outer region of the LSI chip 900, and I/O pads 902 and I/O macro groups (signal I/O macro, VSS I/O macro) 903, 904, 905, and 966 are placed in the inner region for input and/or output of signals and VSS. FIG. 2 shows some hatched boxes as part of the I/O pads 902 and I/O macro groups 903 to 906. The hatching indicates that those elements share a common VSS potential.

The difference between the LSI chip 800 of FIG. 1 and the ESD-protected LSI chip 900 of FIG. 2 is that the latter LSI chip 900 has bidirectional diodes 903a, 904a, 905a, and 906a to connect VSS I/O macros (depicted as double-line boxes) of each I/O macro group 903 to 906 to their common VSS power line 907. This special structure of the LSI chip 900 provides a bypass for an ESD current, thereby protecting function macro elements from electrostatic damage. Suppose, for example, that an electrostatic voltage is applied to one I/O macro group 903 with respect to the VSS power supply terminal (not shown) of another I/O macro group 906. The resulting discharge current flows from the I/O macro group 903 into the common VSS power line 907 via a bidirectional diode 903a. This current is then routed to the VSS power supply terminal (not shown) of the I/O macro group 906 via another bidirectional diode 906a. The same protection mechanism also applies to ESD on the other I/O macro groups 904 to 906.

However, the above-described conventional LSI chip design consumes a certain amount of chip space to implement common power lines shared by a plurality of function macros. This would restrict the layout of other function macro circuits and the like, thus making it difficult to achieve efficient space usage.

### SUMMARY OF THE INVENTION

In view of the foregoing, it is an object of the present invention to provide a semiconductor device with a space-saving design of common power lines shared by a plurality of function macros.

To accomplish the above object, the present invention provides a semiconductor device having a plurality of wiring layers, a moisture-protective ring, and a plurality of function macros. Each function macro has a power supply terminal that is electrically connected to the moisture-protective ring. This connection provides a common electrical potential for the function macros.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows a simplified layout of a conventional LSI chip with a moisture-protective ring.

FIG. 2 shows a simplified layout of a conventional LSI chip with ESD protection capabilities.

FIG. 3 shows a simplified layout of an LSI chip according to a first embodiment of the present invention.

FIG. 4 shows an equivalent circuit of the LSI chip of the first embodiment.

FIG. 5 shows a simplified layout of an LSI chip according to a second embodiment of the present invention.

FIG. 6 shows an equivalent circuit of the LSI chip of the second embodiment.

FIG. 7 is a cross-sectional view of an LSI chip having a moisture-protective ring connected with a VSS power supply terminal section at the uppermost wiring layer.

FIG. 8 is a cross-sectional view of an LSI chip having a moisture-protective ring connected with a VSS power supply terminal section at a wiring layer other than the uppermost layer.

FIG. 9 is a cross-sectional view of an LSI chip having a moisture-protective ring connected with a VSS power supply terminal section at a plurality of wiring layers.

FIGS. 10 and 11 are a cross-sectional view and a plan view of an LSI chip having a double moisture-protective ring connected with a VSS power supply terminal section.

FIGS. 12A and 12B show two possible layouts of an LSI chip with I/O pads located on top of I/O macros.

### DESCRIPTION OF THE PREFERRED EMBODIMENTS

Preferred embodiments of the present invention will now be described in detail below with reference to the accompanying drawings, wherein like reference numerals refer to like elements throughout.

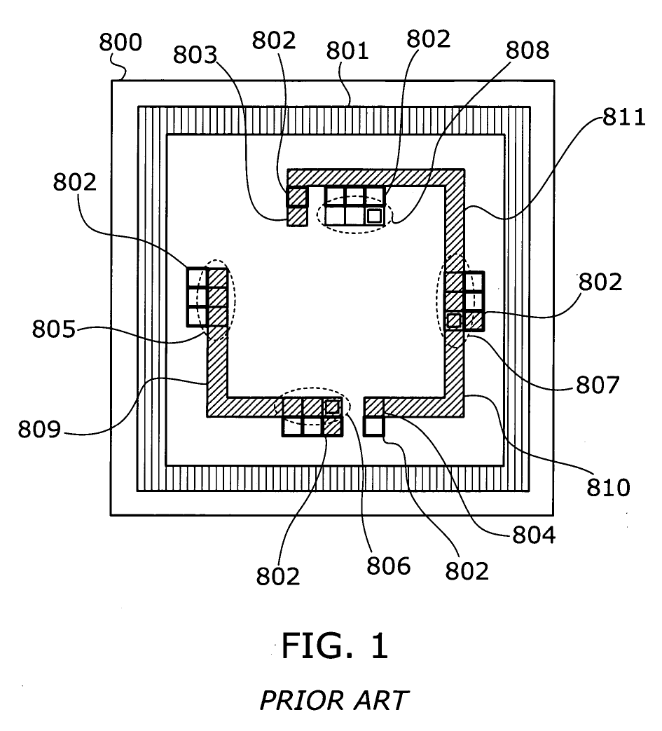

A first embodiment of the present invention is directed to a space-saving design of an LSI chip having separate VSS power line connections for different kinds of function macros to achieve improved noise reduction. In other words, the first embodiment is intended to improve the conventional LSI chip design described in an earlier section (see FIG. 1).

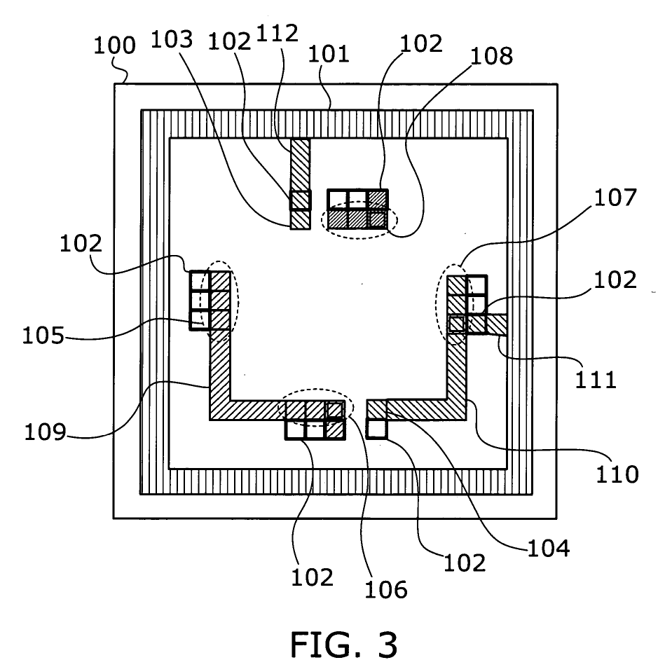

FIG. 3 shows a simplified layout of an LSI chip according to the first embodiment of the present invention. This LSI chip 100 has a moisture-protective ring 101 in its outer region to protect function macros and wiring patterns located inside the ring from moisture intrusion. The moisture-protective ring 101 is made of the same material used for wiring of the LSI chip 100 (e.g., aluminum or copper). In FIG. 3, the bold-line boxes represent I/O pads 102, and the other small boxes are I/O macros 103 and 104 and I/O macro groups 105, 106, 107, and 108. I/O macros are function macro circuits for input and/or output of signals or for connection of VSS voltage. While the LSI chip 100 actually has other types of function macros, FIG. 3 omits them for the sake of simplicity.

More specifically, the I/O macros shown in FIG. 3 include VSS I/O macros (indicated by the double-line boxes) and signal I/O macros (indicated by the other boxes). The LSI chip 100 sends and receives various signals to/from external circuitry through the signal I/O macros and their corresponding I/O pads 102. VSS power supply terminals of function macros are also wired to the external circuitry through the VSS I/O macros and their corresponding I/O pads 102. Although not shown in FIG. 3, the I/O macros 103 and 104 are coupled to arithmetic/logic operators, memory modules, or other function macros, as are the I/O macro groups 105 to 108.

Also formed on the LSI chip 100 of the first embodiment are VSS power lines 109, 110, 111, and 112. The I/O macros of the LSI chip 100 are divided into three clusters. The first cluster includes two individual I/O macros 103 and 104 and one I/O macro group 107. The second cluster includes two I/O macro groups 105 and 106. The third cluster is formed from one I/O macro group 108. It is required to provide a separate VSS power connection for each of those I/O macro clusters.

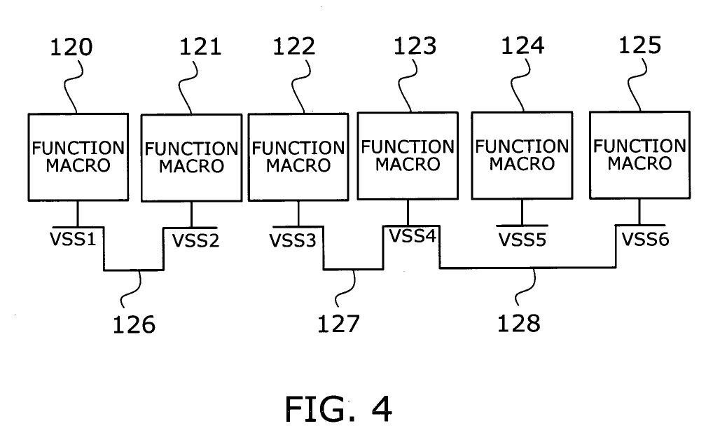

FIG. 4 shows an equivalent circuit of the LSI chip 100 according to the first embodiment of the invention. The leftmost two function macros 120 and 121 are of the same category, the second cluster. The function macros 120 and 121 correspond to the I/O macro groups 105 and 106 shown in FIG. 3, respectively. The next two function macros 122 and 123 and the rightmost function macro 125 belong to another category, the first cluster. The function macro 122 corresponds to the I/O macro 104 shown in FIG. 3, the function macro 123 corresponds to the I/O macro group 107, and the function macro 125 corresponds to the I/O macro 103. The second-to-the-right function macro 124 belongs to yet another category, the third cluster. It corresponds to the I/O macro group 108 shown in FIG. 3.

As mentioned earlier, the LSI chip 100 of the first embodiment provides a separate VSS connection for each different category of function macros to improve the noise reduction. The first two function macros 120 and 121 fall into the same category and thus share a common VSS potential through a VSS power line 126 that connects their VSS power supply terminals VSS1 and VSS2 together. Similarly, the function macros 122, 123, and 125 of another category share a common VSS potential through VSS power lines 127 and 128 that connect their respective VSS power supply terminals VSS3, VSS4, and VSS6. The VSS power supply terminal VSS5 of the function macro 124 is isolated from any other function macros. The VSS power line 126 in the equivalent circuit of FIG. 4 corresponds to the VSS power line 109 shown in the layout diagram of FIG. 3. The VSS power line 127 in FIG. 4 corresponds to the VSS power line 110 in FIG. 3. The circuit layout described up to this point is similar to the conventional layout described in an earlier section (see FIG. 1).

The VSS power line 128 between the function macros 123 and 125 would be long and could possibly interfere with other circuits if it was routed inside the moisture-protective ring 101. According to the first embodiment of the present invention, the LSI chip 100 has VSS power lines 111 and 112 to connect the VSS power supply terminals (not shown in FIG. 3) of the I/O macro group 107 and I/O macro 103. The other ends of these VSS power lines 111 and 112 are electrically connected to the moisture-protective ring 101, so that the moisture-protective ring 101 will serve as part of the VSS power line 128 in FIG. 4. While the moisture-protective ring 101 might encounter moisture, the possible resulting damage to the moisture-protective ring 101 would not be large enough to impair its functionality as an electrically conductive path providing VSS connections. Advantageously the layout design of the first embodiment reduces the wiring space for routing the VSS power line 128, which would occupy a part of an inner region of the moisture-protective ring 101 in the conventional layout design.

In the example of FIG. 3, the I/O macro 104 is relatively close to its associated I/O macro group 107. The VSS power line 110 is therefore drawn in a conventional way (i.e., without using the moisture-protective ring 101) to allow the I/O macro 104 to share its VSS potential with the I/O macro 103 and I/O macro group 107. It is also possible, however, to draw a short line from the moisture-protective ring 101 to the I/O macro 104, instead of the VSS power line 110 shown in FIG. 3.

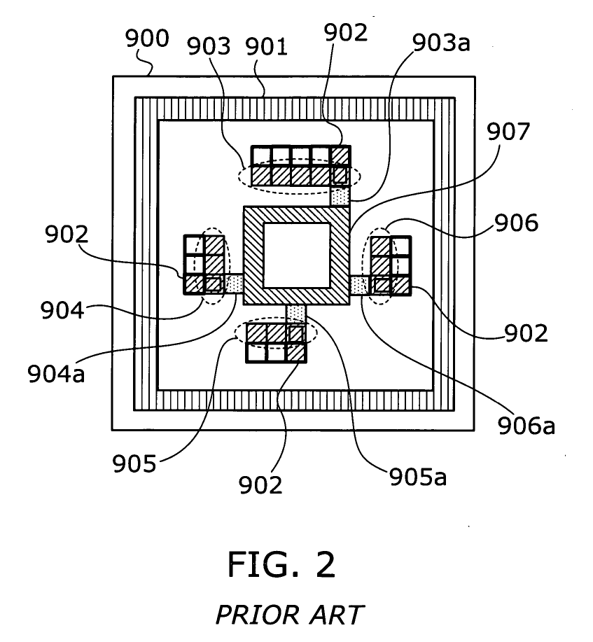

The second embodiment is directed to a space-saving design of an ESD-protected LSI chip. That is, the second embodiment is to improve the conventional LSI chip design described in FIG. 2.

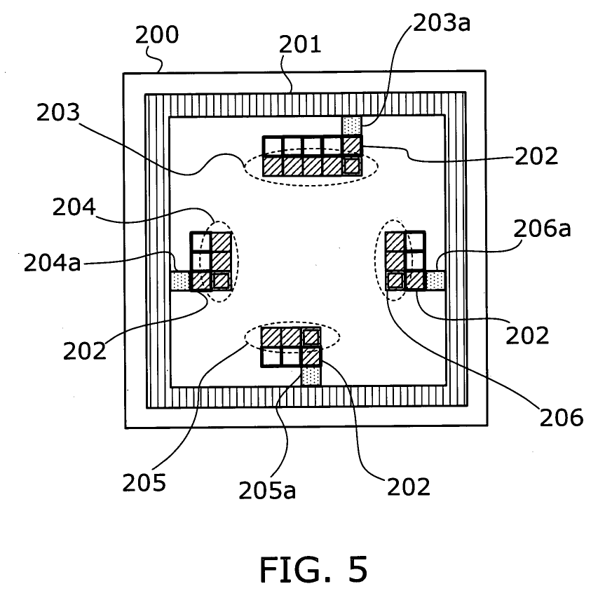

FIG. 5 shows a simplified layout of an LSI chip according to the second embodiment of the invention. The illustrated LSI chip 200 has a moisture-protective ring 201 made of aluminum, copper, or other metal in its outer region. Other elements shown in FIG. 5 are I/O pads 202 and I/O macro groups 203, 204, 205, and 206, the functions of which are similar to those in the LSI chip 100 of the first embodiment. Specifically, the double-line boxes indicate VSS I/O macros, and the other boxes represent signal I/O macros. Various signals are supplied from external circuitry to the LSI chip 200 through the I/O pads 202 coupled to those signal I/O macro. FIG. 5 shows some hatched boxes as part of the I/O pads 202 and I/O macro groups 203 to 206. Here the hatching indicates that those pads and macros share a common VSS potential.

The LSI chip 200 further has bidirectional diodes 203a, 204a, 205a, and 206a to connect the moisture-protective ring 201 with the VSS power supply terminal (not shown) of each I/O macro group 203 to 206. A bidirectional diode is a circuit composed of at least two opposite diodes wired in parallel. Although not shown in FIG. 5, the I/O macro groups 203 to 206 are connected to arithmetic/logic operators, memory modules, or other function macros.

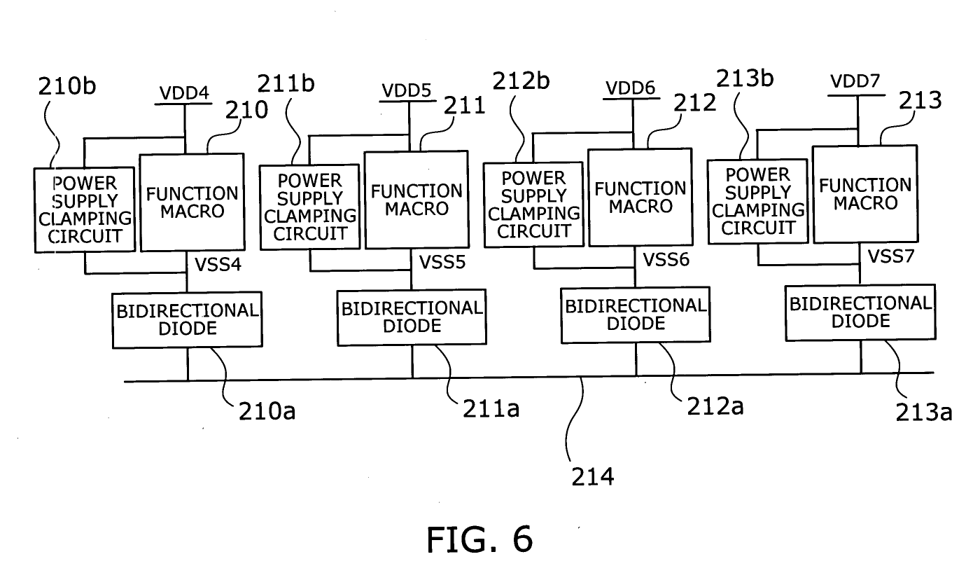

FIG. 6 shows an equivalent circuit of the LSI chip 200 of the second embodiment. The function macros 210, 211, 212, and 213 shown in FIG. 6 correspond to the I/O macro groups 203, 204, 205, and 206, respectively. VSS4 to VSS7 refer to the VSS power supply terminals of those function macros 210 to 213, which are connected to a common VSS power line 214 via bidirectional diodes 210a, 211a, 212a, and 213a. The bidirectional diodes 210a to 213a shown in FIG. 6 correspond to the bidirectional diode 203a to 206a shown in FIG. 5. To protect the function macros 210, 211, 212, and 213 against ESD, power supply clamping circuits 210b, 211b, 212b, and 213b are placed between VDD4 and VSS4, VDD5 and VSS5, VDD6 and VSS6, and VDD7 and VSS7, respectively. VDD4 to VDD7 refer to the VDD power terminals of function macros 210 to 213, respectively. The power supply clamping circuits 210b to 213b may be an integral part of the corresponding function macros 210 to 213.

In actually implementing the circuit of FIG. 6, the common VSS power line 214 could possibly interfere with other circuits if it was routed inside the moisture-protective ring 201 as in the conventional LSI chip 900 described in FIG. 2. According to the second embodiment of the invention, the LSI chip 200 of FIG. 5 is designed to connect the VSS power supply terminals (not shown) of each I/O macro group 203 to 206 with the moisture-protective ring 201 through bidirectional diodes 203a to 206a. Here the VSS power line 214 functions as a common VSS power line. This space-saving layout design greatly reduces the wiring space required for a common VSS power line. While the bidirectional diodes 203a to 206a shown in FIG. 5 are discrete components, they may actually be implemented as part of VSS I/O macros, without consuming much floor space.

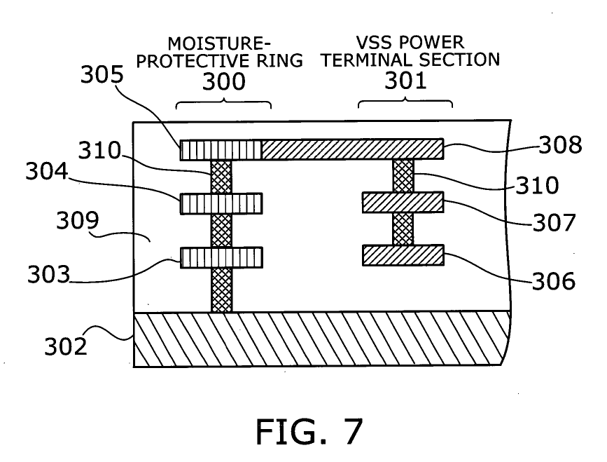

There are several ways to interconnect VSS power supply terminals to a moisture-protective ring. FIG. 7 is a cross-sectional view of an LSI chip having a moisture-protective ring connected with a VSS power supply terminal section at the uppermost wiring layer. Specifically, FIG. 7 illustrates a multilayer structure of an LSI chip, where a moisture-protective ring 300 and a VSS power supply terminal section 301 of a certain function macro are fabricated on a semiconductor substrate 302. The moisture-protective ring 300 has a structure of three conductive layers 303, 304, and 305 alternating with interlayer insulation films 309. The three layers 303, 304, and 305 are interconnected by contacts 310. Aluminum, copper, or other appropriate material is used to form the moisture-protective ring layers 303, 304, and 305, the wiring layers 306, 307, and 308 of the VSS power supply terminal section 301, and the contacts 310. In the present embodiment of FIG. 7, the uppermost wiring layer 308 of the VSS power supply terminal section 301 is extended to the uppermost layer 305 of the moisture-protective ring 300.

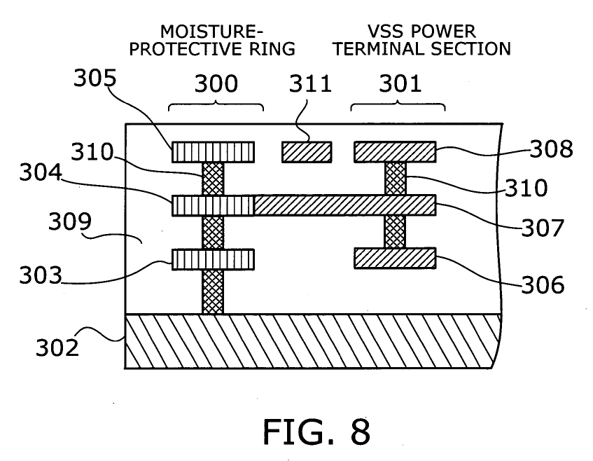

FIG. 8 is a cross-sectional view of an LSI chip having a moisture-protective ring connected with a VSS power supply terminal section at a wiring layer other than the uppermost one. Because of the similarity to the layer structure described in FIG. 7, like reference numerals are affixed to like elements.

In the example of FIG. 8, there is a signal line 311 at the uppermost wiring layer, blocking the shortest path from the VSS power supply terminal section 301 to the VSS power supply terminal section 301 at that layer. Instead of detouring at the uppermost layer, a middle wiring layer 307 of the VSS power supply terminal section 301 is extended to the corresponding layer 304 of the moisture-protective ring 300.

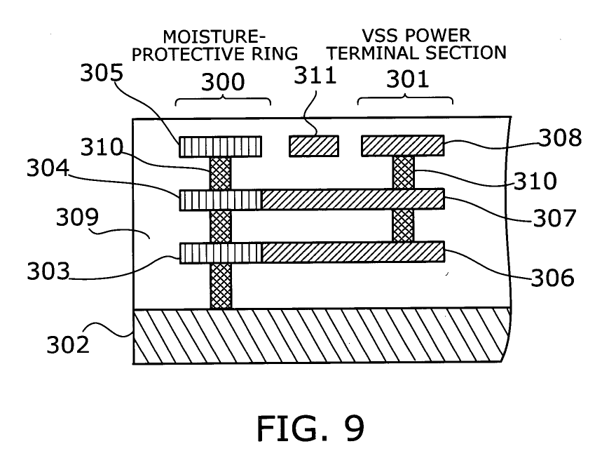

FIG. 9 is a cross-sectional view of an LSI chip having a moisture-protective ring connected with a VSS power supply terminal section at a plurality of wiring layers. Because of the similarity to the layer structure described in FIGS. 7 and 8, like reference numerals are affixed to like elements.

As can be seen from the example of FIG. 9, two wiring layers 306 and 307 of the VSS power supply terminal section 301 are used to connect with the moisture-protective ring layers 303 and 304. The use of multiple layers enhances the conductivity between the VSS power supply terminal section 301 and the semiconductor substrate 302. This means that the VSS pattern allows a larger noise current to flow from the VSS power supply terminal section 301 to the semiconductor substrate 302, without increasing the electrical potential of the VSS power supply terminal section 301 too much.

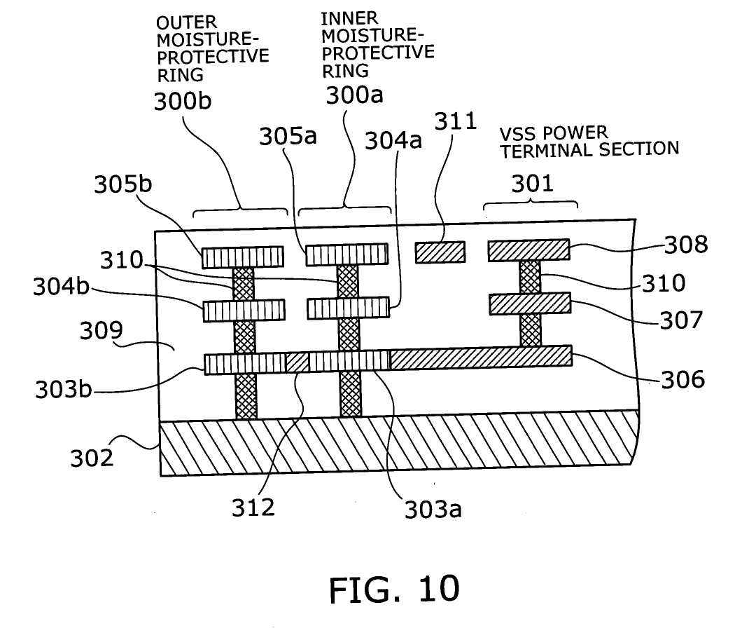

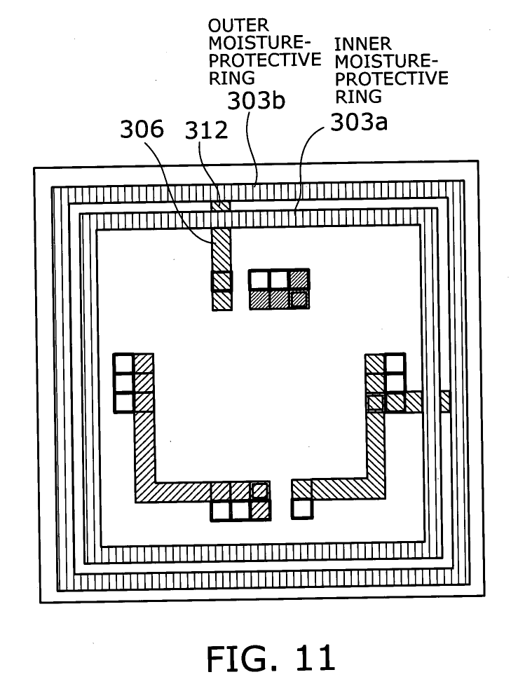

FIG. 10 is a cross-sectional view of an LSI chip having a double moisture-protective ring connected with a VSS power supply terminal section, and FIG. 11 shows a plan view of an inner layer of that LSI chip. The LSI chip has an inner moisture-protective ring 300a and an outer moisture-protective ring 300b. The inner moisture-protective ring 300a is formed from three layers 303a, 304a, and 305a interconnected by contacts 310. Likewise, the outer moisture-protective ring 300b is formed from three layers 303b, 304b, and 305b interconnected by contacts 310.

The illustrated double ring structure protects the function macros and wiring patterns inside the ring more effectively. While the inner and outer moisture-protective rings 300a and 300b might encounter moisture, the possible resulting damage to those rings 300a and 300b would not be large enough to impair their functionality as an electrically conductive path providing VSS connections. Particularly the inner ring 300b will serve as a safe guard in case the outer ring 300a fails.

A wiring layer 306 of the VSS power supply terminal section 301 is extended to the layer 303a of the inner moisture-protective ring 300a. The layer 303a is further connected with the layer 303b of the outer moisture-protective ring 300b through a wiring layer 312. This structure enhances the conductivity between the VSS power supply terminal section 301 and semiconductor substrate 302. That is, a larger current can flow from the VSS power supply terminal section 301 to the semiconductor substrate 302, without increasing the electrical potential of the VSS power supply terminal section 301 too much. This advantage will be further enhanced by using two or more layers for connection of the inner and outer moisture-protective rings 300a and 300b.

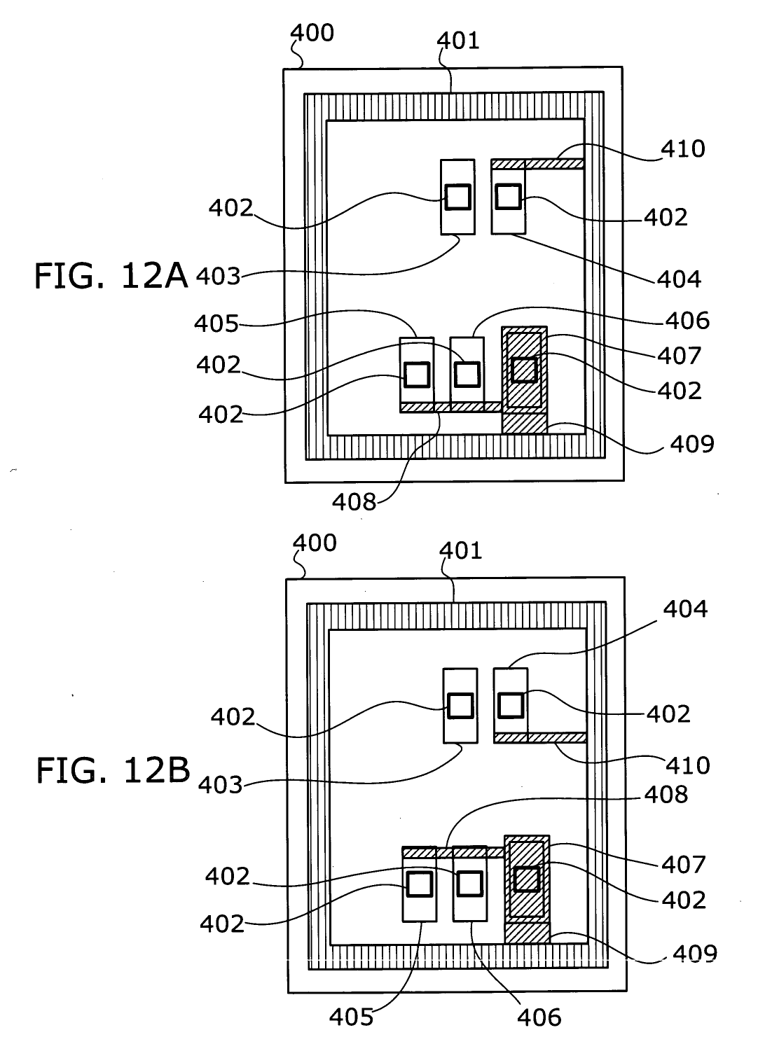

The present invention should not be limited to the particular layout of I/O macros or I/O pads shown in FIG. 3 or FIG. 5. The present invention can also be applied to other circuit layouts, such as the ones depicted in FIGS. 12A and 12B. Specifically, FIGS. 12A and 12B show two possible wiring designs of an LSI chip with I/O pads located on top of I/O macros.

More specifically, FIG. 12A shows an LSI chip 400 having a moisture-protective ring 401. Located inside the moisture-protective ring 401 are signal I/O macros 403, 404, 405, and 406 and a VSS I/O macro 407. An I/O pad is fabricated on each of these macros.

The signal I/O macros 404 to 406 and VSS I/O macro 407 are supposed to share a VSS potential. To implement this, the present invention proposes to route VSS power lines as follows. First, a VSS power line 408 is drawn from signal I/O macros 405 and 406 to the VSS I/O macro 407 (every macro has its own VSS power supply terminal for connection of such a VSS power line). This VSS connection does not use the moisture-protective ring 401 since those macros 405 to 407 are relatively close to each other. Then, another VSS power line 409 is drawn from the VSS I/O macro 407 to the moisture-protective ring 401, and yet another VSS power line 410 is drawn from the moisture-protective ring 401 to the signal I/O macro 404. That is, the moisture-protective ring 401 is used to extend the VSS connection to the signal I/O macro 404, which is relatively distant from the VSS I/O macro 407. This design saves the precious wiring space on the LSI chip.

The difference between FIG. 12A and FIG. 12B is the location of VSS power lines 408 and 410. Specifically, in FIG. 12A, these VSS power lines 408 and 410 are routed across the signal I/O macros 404, 405, and 406 on their outer side (i.e., on the side near the moisture-protective ring 401), whereas, in FIG. 12B, they run on their inner side (i.e., on the side closer to the center of the LSI chip 400). As can be seen from the above examples, the present invention can be implemented in various ways in actual LSI chip designs.

In conclusion, the present invention is directed to a semiconductor device having a plurality of wiring layers, a moisture-protective ring, and a plurality of function macros. According to the present invention, the power supply terminal of each function macro is electrically connected to the moisture-protective ring. This connection enables the moisture-protective ring to serve as part of a power supply line to provide a common electrical potential for the function macros. The proposed architecture reduces the wiring space required for routing common-potential power lines inside the moisture-protective ring, thus contributing to space-saving design of semiconductor devices.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A semiconductor device, comprising:
a plurality of wiring layers;
a moisture-protective ring; and
a plurality of function macros each having a power supply terminal that is electrically connected to the moisture-protective ring to provide a common electrical potential for the function macros.

2. The semiconductor device according to claim 1, wherein the power supply terminals are VSS power supply terminals.

3. The semiconductor device according to claim 1, wherein the power supply terminals are connected to the moisture-protective ring at one of the wiring layers.

4. The semiconductor device according to claim 3, further comprising a wiring pattern interposed between the power supply terminals and the moisture-protective ring at another one of the wiring layers.

5. The semiconductor device according to claim 1, wherein the power supply terminals are connected to the moisture-protective ring at two or more of the wiring layers.

6. The semiconductor device according to claim 5, further comprising a wiring pattern interposed between the power supply terminals and the moisture-protective ring at one of the wiring layers.

7. The semiconductor device according to claim 1, wherein the moisture-protective ring has a double ring structure comprising an outer ring and an inner ring that are electrically connected to each other.

8. The semiconductor device according to claim 7, wherein the electrical connection between the outer and inner rings is made at a plurality of layers.

9. The semiconductor device according to claim 1, further comprising a power line locally interconnecting the power line terminals of adjacent function macros belonging to a group.

10. The semiconductor device according to claim 9, wherein the power line runs across the adjacent function macros on a side closer to the moisture-protective ring.

11. The semiconductor device according to claim 9, wherein the power line runs across the adjacent function macros on a side closer to the center of the semiconductor device.

12. The semiconductor device according to claim 1, further comprising bidirectional diodes to connect the power supply terminals to the moisture-protective ring.

13. The semiconductor device according to claim 12, wherein the moisture-protective ring has a double ring structure comprising an outer ring and an inner ring that are electrically connected to each other.

14. The semiconductor device according to claim 13, wherein the electrical connection between the outer and inner rings is made at a plurality of layers.

15. The semiconductor device according to claim 12, further comprising a power line locally interconnecting the power line terminals of adjacent function macros belonging to a group.

16. The semiconductor device according to claim 15, wherein the power line runs across the adjacent function macros on a side closer to the moisture-protective ring.

17. The semiconductor device according to claim 15, wherein the power line runs across the adjacent function macros on a side closer to the center of the semiconductor device.
